(19) United States
(12) Patent Application Publication
(10) Pub. No.: US 2022/0056935 A1
(43) Pub. Date: Feb. 24, 2022

(54) Hexagonet

(71) Applicants: Philip Andrew Scott, Sanctuary Cove (AU); Fatiha Sahnoune, Sanctuary Cove (AU)

(72) Inventors: Philip Andrew Scott, Sanctuary Cove (AU); Fatiha Sahnoune, Sanctuary Cove (AU)

(21) Appl. No.: 17/407,481

(22) Filed: Aug. 20, 2021

Related U.S. Application Data
(60) Provisional application No. 63/068,661, filed on Aug. 21, 2020.

(51) Int. Cl. F15D 1/10

(52) U.S. Cl. CPC F15D 1/10

(57) ABSTRACT

An innovative hexagonet provides a unique surface structure to achieve optimal tribological performance of any solid objects. The hexagonet comprises fractal hexagons and each fractal hexagon include regular hexagons in fractal form that can reduce friction and improve interactions of an object with any other objects and environment, thereby increasing the performance and reliability of the object by increasing balance and consistency in motion and at rest. Once integrated to the object, the hexagonet can form a protective surface which is repellent to other matter, thus, providing slippery, anti-fouling and anti-bacterial properties. Additionally, the protective surface creates a tribological effect which significantly reduces heat and disturbance, contamination and wear and tear resulting in reduction of energy consumption of the object. Further, the versatile and effective hexagonet can provide various applications to the object in solid-to-solid, solid-to-liquid, solid-to-air interactions, etc.

The current application claims a priority to the U.S. Provisional Patent application Ser. No. 63/068,661 filed on Aug. 21, 2020.

### FIELD OF THE INVENTION

The present invention generally relates to tribological structures. More specifically, the present invention relates to a surface structure with a unique design that is made entirely of a geometric pattern featuring fractal hexagons to provide optimal surface tribology for a solid object interacting with any other objects and/or environment. The present invention is used as a coating/film or to form the body and surface of a solid object.

### BACKGROUND OF THE INVENTION

An object with a surface designed to provide tribological features and improved finish, including anti-stick characteristics, is in demand.

The surfaces of articles and products can have various beneficial characteristics, and the initial topography of the surfaces used in various objects can vary depending on their intended use. For example, a metal surface may be polished with aluminum oxide to give it a mirror finish. Likewise, an article's surfaces can interact with the environment and/or other objects to form various surface films: a metal surface can interact with the environment to form oxides, nitrides, or hydroxides, and the surface of a rubber tire can produce friction with the road surface, allowing the wheels to exert force on the road that propels the vehicle.

In many circumstances, reducing friction can be important and even critical to achieve desired and/or optimal performance. For example, ice hockey depends on a puck's being able to slide across ice, as does curling. Likewise, a golf ball's surface may be designed to part the air around the golf ball, reducing drag/friction and making the ball travel farther. An airplane's exterior shape and surfaces need to be specifically configured for optimal tribology to achieve high speed and at the same time save energy.

Various product surfaces can include lubricants that reduce friction. Many compounds can be added to conventional oils to act as extreme pressure or anti-wear additives in lubricants. Solid film lubricants can also be applied to surfaces so as to reduce adhesion, friction, and wear.

Various manufacturers have attempted to produce a range of beneficial surface effects through the surface design and treatment of a product, but many times such beneficial effects are limited to a specific product or structure. Thus, there is a need to develop a material and technology that solves these problems.

The present invention is intended to address problems associated with and/or otherwise improve on conventional technology and articles of manufacture through an innovative surface structure that is designed to provide a tribological means of producing various beneficial effects while incorporating other problem-solving features.

### SUMMARY OF THE INVENTION

The present invention offers a user an innovative hexagonet that can be integrated and/or attached to any solid objects. Once applied to an object, the hexagonet provides a unique surface structure to achieve optimal tribological performance during interactions of the object with any other objects and/or environment. The hexagonet comprises fractal hexagons that can reduce both friction and the force of friction, thereby increasing the performance and reliability of the object by increasing balance and consistency in motion and at rest. Each fractal hexagon comprises regular hexagons in fractal form, with each regular hexagon repeating in a decreasing size, ultimately to a nano scale, thus, can provide a protective surface which is repellent to other matter and will not allow bacteria, germs, water or indeed any kind of particle to adhere to the surface for any period of time. Additionally, the design of the hexagonet provides slippery, anti-fouling and anti-bacterial properties and promotes a decrease in contamination thus enabling the object to be more effective and less hazardous than objects without the present invention.

Positioned on the exterior surface of the object the hexagonet of the present invention creates a tribological effect to significantly reduce friction while creating less heat and disturbance, less contamination and less wear and tear comparing with any other existing objects. The hexagonet can be used to significantly reduce friction between the hexagons and the environment and balance in motion of the object to achieve efficient motion/balance and save energy: faster with less energy than objects without the present invention. Thus, the hexagonet of present invention can achieve versatile applications for the solid object, including, but not limited to, solid-to-solid, solid-to-liquid, and solid-to-air interactions, etc.

### BRIEF DESCRIPTION OF THE DRAWINGS

FIG. 1 is an isometric perspective view of the present invention.

FIG. 2 is a top front side view of an alternative embodiment of the present invention.

FIG. 3 is a side cross-sectional view of the present invention.

### DETAIL DESCRIPTIONS OF THE INVENTION

All illustrations of the drawings are for the purpose of describing selected versions of the present invention and are not intended to limit the scope of the present invention.

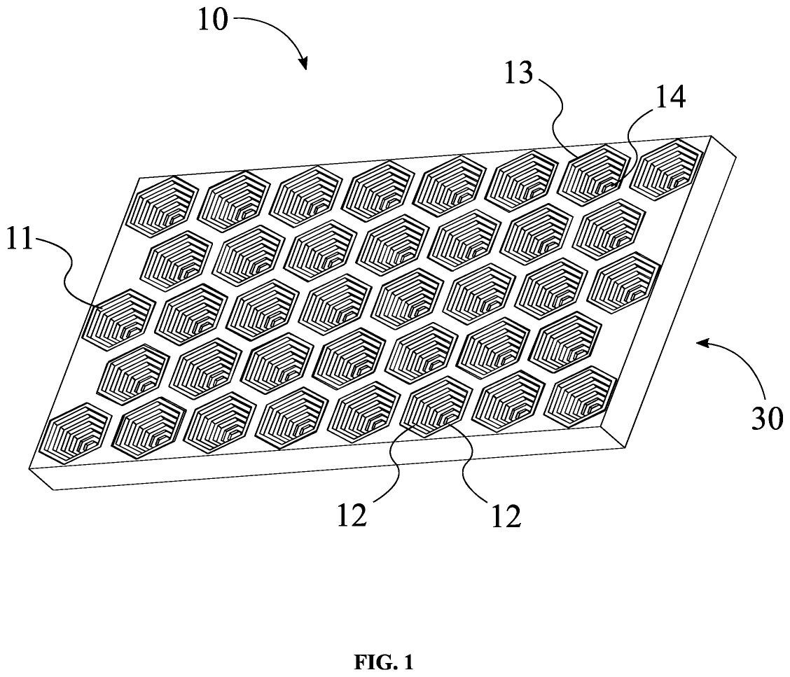

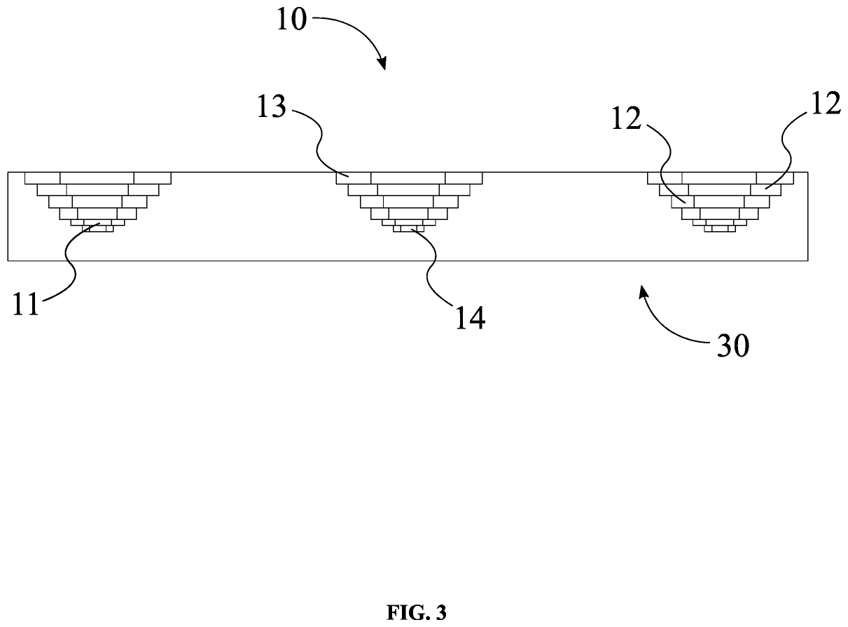

As can be seen in FIG. 1 to FIG. 3, the present invention comprises an innovative hexagonet that provides a unique surface structure to achieve optimal tribological performance of an object while interacting with any other objects and/or environment. The tribological technology used in the present invention can reduce both friction and the force of friction, thereby increasing the performance and reliability of the object/article or product by increasing balance and consistency in motion and at rest. The hexagonet of the present invention provides an improved finish for the external surface of the object that can benefit from an anti-stick surface. This external finish can be completely integral to the material of the object or can be an additional layer or layers applied to the object as a surface coating application. The hexagonet comprises regular hexagons in fractal form, with each regular hexagon repeating in a decreasing size, ultimately to a nano scale. This nano scale fractal hexagon finish can provide a protective surface which is repellent to other matter and will not allow bacteria, germs, water or indeed any kind of particle to adhere to the surface for any period of time. This provides an organic and nontoxic improvement to the surface via the unique design. Additionally, this design is geometric in principle, and mimics nature in its geometric and symmetric properties. Thus, the design is slippery, anti-fouling and anti-bacterial and promotes a decrease in contamination and ensures the object to be more effective and less hazardous than objects without the present invention. The surface of the object integrated with the hexagonet of the present invention creates a tribological effect to significantly reduce friction while creating less heat and disturbance, less contamination and less wear and tear comparing with any other existing objects. The hexagonet can be used to reduce friction into organized interactions between the hexagons and the environment and balance in motion of the object to achieve efficient motion/balance and save energy: faster with less energy than objects without the present invention. The benefits derived from the reduced friction of the hexagonet with the hexagon pattern will increase the lifespan of the objects with resultant efficiency gains and cost savings.

The applications of the hexagonet include, but are not limited to, solid-to-solid interactions such as surfaces of motor vehicles, gears, engine parts, trains, solid-to-liquid such as boats, pipes, vessels, solid-to-air such as balls, golf clubheads, airplanes, rockets, bullets, etc. The hexagonet can be applied to objects with materials of any density. The hexagonet can be applied to the entire surface of any object, or certain sections of the object (sides, facets, etc.) as deemed appropriate and beneficial. Further, the hexagonet can be applied to an internal layer of the object and/or can be applied gradually. A static product also receives benefit from the non-stick uniform property of the present invention. In a state of rest the product is effectively smooth, thereby repelling matter coming into contact with the surface virtually instantly.

As can be seen in FIG. 1 to FIG. 3, the hexagonet 10 of the present invention for providing optimal surface tribology comprises at least one fractal hexagon 11 and a solid object 30. More specifically, each fractal hexagon 10 exteriorly positioned on the solid object 30. Additionally, each fractal hexagon 11 comprises a plurality of hexagons 12, which may include, but is not limited to, concentric hexagons, nonconcentric hexagons, etc. The concentric fractal hexagons 12 provide the object 30 featuring this surface a systematic and repeating treatment of the interaction between the object and the environment. Through the design of concentric hexagons, the hexagonet of the present invention establishes an organized action and reaction, thus ensuring an effective treatment of energy and interaction with any other object, surface or environment to creates an inherent balance in motion or at rest. The pattern of the fractal hexagon 11 produces a dynamic effect on the airflow/fluid flow surrounding the solid object 30. The tribological technology established by the present invention reduces the turbulence of the air/fluid around the solid object 30 using the design and on the surface of the solid object 30, thus reducing the friction and the force of the friction, thereby increasing the performance and reliability of the solid object 30 through balance and consistency. The resulting optimal surface topography of the present invention positively affects and impacts the aerodynamics of the designated solid object 30 as an external application or as part of the outer surface layer skin patterns. The ability to repel any foreign matter from the surface of the solid object 30 shows a beneficial effect on the airflow/fluid flow and drag of the solid object 30 in motion. The aerodynamic and tribological benefits of the pattern enhances the performance in motion of the solid object 30 when utilized in an even and uniform manner. Additionally, the present invention positively improves the sound/resonance performance of the solid object 30 in motion featuring the surface technology, further increasing the friction reduction and further adding to the stability. Further, the fractal hexagon 11 creates a thermo protective effect which adapts to varying climatic conditions, which balances the friction reactions of the surroundings of the solid object 30 thus keeping the airflow/fluid flow harmonious.

As can be seen in FIG. 1 to FIG. 3, in the preferred embodiment of the present invention, the each of the plurality of hexagons 12 of the fractal hexagon 11 comprises an outermost hexagon 13 and an innermost hexagon 14. More specifically, the outermost hexagon 13 of the plurality of hexagons 12 is positioned flush with exterior surface of the solid object 30, and the innermost hexagon 14 of the plurality of hexagons 12 is interiorly positioned in the solid object 30. The entire body of the fractal hexagon 11 is an integral part of the solid object 30 with the exterior surface of the outmost hexagon 13 being flush with the exterior surface of the solid object 30. In some embodiments of the present invention, the at least one fractal hexagon 11 is exteriorly attached to the solid object 30 in any form, which includes, but is not limited to, welding, being applied as a film, coating, etc.

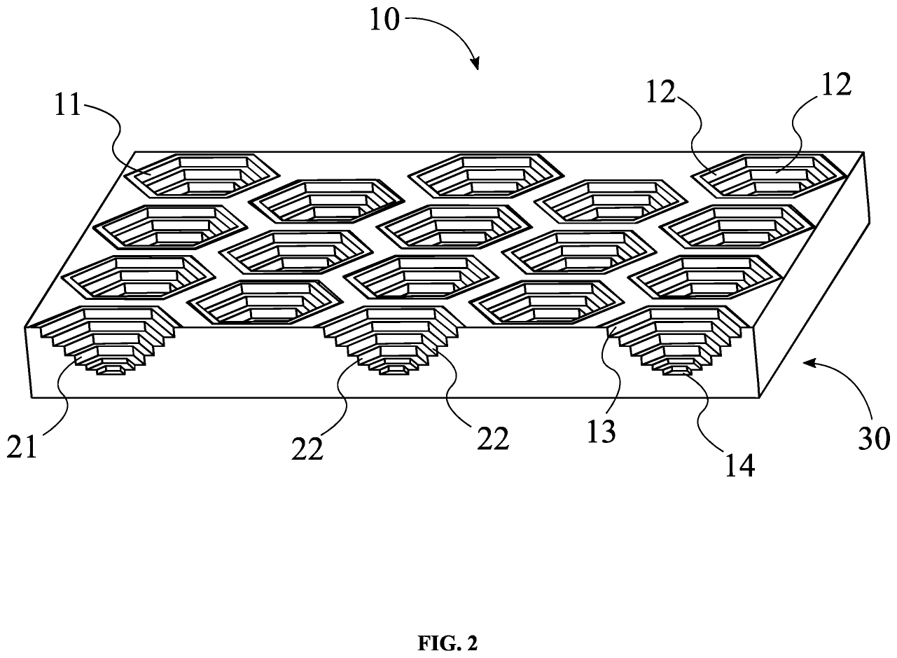

As can be seen in FIG. 2, the at least one fractal hexagon 11 comprises at least one partial fractal hexagon 21 and each partial fractal hexagon 21 comprises a plurality of partial hexagons 22. The partial fractal hexagon 21 provides flexibility to the user to configure the hexagonet 10 of the present invention to actual applications/objects. In some embodiments of the present invention, the user may desire to terminally position the at least one partial fractal hexagon 21 on the solid object 30, including, but not limited to, edges, corners, etc. In this way, the specifically designed surface finish can be applied completely to the exterior as skin of the solid object 30 or only used in a partial capacity in areas where the present invention is required and beneficial.

In some embodiments, the numerous design members of the hexagonet 10 can be impressed onto the surface of the solid object 30 when the hexagonet 10 is injection molded. The hexagonet 10 of the present invention is not subject to any particular limitations on the inner construction of the solid object 30. In short, the invention is applicable to all types of solid object 30, including objects made of a multilayer construction and one or more intermediate layers situated between the core and the cover, which can be made of the hexagonet 10 of the present invention. The hexagonet 10 may be of any shape, size, and material suitable for the solid object 30 or any article that may use the present invention as a cover or an outer surface. Such suitable materials for the solid object 30 that interact with air flow environments (e.g., sports balls, including golf balls) may include, but are not limited to, a thermoplastic material or a blend of thermoplastic material. In some embodiments, ionomer carriers may be used to modify the specific gravity of the thermoplastic blend, controlling the moment of inertia and other like properties. In some embodiments, the multiple effects provided by the fractal hexagon 11 may create access to energy in a cyclical and ongoing condition, effectively recycling and optimizing the energy forces. The multiple effects and benefits of the design and technology of the present invention, as applied to the surface of any relevant product, shall improve the efficiency, cleanliness, and performance characteristics of the product in a multitude of ways. Cleanliness can be improved via the nonstick properties of the solid object 30 surface by creating a lasting antibacterial finish. The surface tribology may also offer benefits related to heat and UV resistance.

Although the invention has been explained in relation to its preferred embodiment, it is to be understood that many other possible modifications and variations can be made without departing from the spirit and scope of the invention as hereinafter claimed.

What is claimed is:

1. A hexagonet for providing optimal surface tribology comprising:
at least one fractal hexagon;
a solid object;
each fractal hexagon being exteriorly positioned on the solid object; and
each fractal hexagon comprising a plurality of hexagons.

2. The hexagonet for providing optimal surface tribology comprising as claimed in claim 1 comprising:
the plurality of hexagons comprising concentric hexagons.

3. The hexagonet for providing optimal surface tribology comprising as claimed in claim 1 comprising:
the plurality of hexagons comprising nonconcentric hexagons.

4. The hexagonet for providing optimal surface tribology comprising as claimed in claim 1 comprising:
the each of the plurality of hexagons comprising an outermost hexagon and an innermost hexagon;
the outermost hexagon of the plurality of hexagons being positioned flush with exterior surface of the solid object; and
the innermost hexagon of the plurality of hexagons being interiorly positioned in the solid object.

5. The hexagonet for providing optimal surface tribology comprising as claimed in claim 1 comprising:
the at least one fractal hexagon being exteriorly attached to the solid object.

6. The hexagonet for providing optimal surface tribology comprising as claimed in claim 1 comprising:
the at least one fractal hexagon comprising at least one partial fractal hexagon; and
each partial fractal hexagon comprising a plurality of partial hexagons.

7. The hexagonet for providing optimal surface tribology comprising as claimed in claim 6 comprising:
the at least one fractal hexagon being terminally positioned on the solid object.
